(19) United States
(12) Patent Application Publication
(10) Pub. No.: US 2024/0403066 A1
(43) Pub. Date: Dec. 5, 2024

(54) SYSTEM AND METHOD FOR RESTRICTING ACCESS TO A RESOURCE

(71) Applicant: STMicroelectronics International N.V., Geneva (CH)

(72) Inventors: Frederic Ruelle, Marigné-Laillé (FR); Michel Jaouen, Yvre L'eveque (FR)

(21) Appl. No.: 18/676,689

(22) Filed: May 29, 2024

(30) Foreign Application Priority Data
May 30, 2023 (FR) 2305372

(51) Int. Cl. G06F 9/445; G06F 9/50

(52) U.S. Cl. CPC G06F 9/445; G06F 9/5005

(57) ABSTRACT

A computing device includes at least one memory device configured to store a software application, a processing device coupled to the at least one memory device via a bus and configured to execute the software application, and one or more resources capable of being called by the execution of a code in the software application. The at least one memory device, or a further memory device of the computing device, is configured to store a redirection table indicating, based on either or both of a caller address and a called address of a call to one of the resources, a substitute address to which the call is to be forwarded. The computing device further includes a software or hardware for intercepting a call from the software application and selectively redirecting the call based on the redirection table.

### CROSS-REFERENCE TO RELATED APPLICATIONS

The present patent application claims priority from the French patent application filed on 30 May 2023 and assigned application no. FR2305372, the contents of which is hereby incorporated by reference in its entirety.

### TECHNICAL FIELD

The present disclosure relates generally to computer processing systems comprising a processor or microcontroller, and more specifically to systems and methods for restricting access by specific software modules to resources of a computer processing system.

### BACKGROUND

It is known to provide processing environments in which applications may be granted different levels of privilege for accessing resources, such as hardware resources, for example peripheral devices or specific memory regions, or other resources, for example, a software service, a cryptographic service, a specific parameter, or confidential data.

A trusted software application having the required privilege level for accessing a given restricted resource may access it directly using a direct call. In contrast, if a non-trusted application not having the required privilege level wishes to access a restricted resource, it may be necessary to perform a system call that interrupts the application execution, and requests that a system having a higher privilege level, such as the operating system, accesses the resource on behalf of the non-trusted application.

### SUMMARY

In accordance to an embodiment, a computing device includes at least one memory device configured to store a software application, a processing device coupled to the at least one memory device via a bus and configured to execute the software application, and one or more resources capable of being called by the execution of a code in the software application. The at least one memory device, or a further memory device of the computing device, is configured to store a redirection table indicating, based on either or both of a caller address and a called address of a call to one of the resources, a substitute address to which the call is to be forwarded. The computing device further includes a software for intercepting a call from the software application and selectively redirecting the call based on the redirection table. In an embodiment, wherein the one or more resources include one or more hardware resources such as peripheral devices of the computing device. In an embodiment, the one or more resources include one or more memory regions of the at least one memory device. In an embodiment, the software for intercepting the call is configured to compare the caller address of the call with a plurality of reference caller addresses indicated in the redirection table, and in case of a hit, to redirect the call to the substitute address associated in the redirection table with the reference caller address of the call. In an embodiment, the software for intercepting the call is configured to compare the called address of the call with a plurality of reference called addresses indicated in the redirection table, and in case of a hit, to redirect the call to the substitute address associated in the redirection table with the reference called address of the call. In an embodiment, the software for intercepting the call is configured to compare the caller address of the call with a plurality of reference caller addresses indicated in the redirection table and to compare the called address of the call with a plurality of reference called addresses indicated in the redirection table, and in case of a hit for both the caller and called addresses, to redirect the call to the substitute address associated in the redirection table with the reference caller and called addresses of the call. In an embodiment, the one or more resources capable of being called by the execution of the code in the software application include a first resource capable of being called by a call to a first function stored at a first address in the at least one memory device, and a second resource capable of being called by a call to a second function stored at a second address in the at least one memory device. In an embodiment, the software for intercepting the call is stored in the at least one memory device.

In accordance to another embodiment, a computing device includes one or more resources and one or more memory devices configured to store a software application, and a redirection table. The redirection table indicates, based on either or both of a caller address and a called address of a call to one of the one or more resources, a substitute address to which the call is to be forwarded. The computing device further includes a processing device coupled to the one or more memory devices and configured to execute the software application. The processing device is configured to generate the call to the one of the one or more resources. The computing device further includes a circuit for intercepting the call and forwarding the call to the substitute address according to the redirection table. In an embodiment, the circuit includes a first comparator configured to compare the caller address of the call to a reference caller address or reference caller address range, or a second comparator configured to compare the called address of the call to a reference called address or reference called address range. In an embodiment, the circuit further includes one of the one or more memory devices configured to store the redirection table. In an embodiment, the computing device further includes a bus configured to couple the processing device, the one or more memory devices, the one or more resources, and the circuit to each other. In an embodiment, the circuit is configured to update the redirection table. In an embodiment, the one or more resources include one or more hardware resources such as peripheral devices of the computing device. In an embodiment, the one or more resources include one or more memory regions of the one or more memory devices.

In accordance to yet another embodiment, a method of accessing one or more resources of a computing device, the method includes intercepting, by a software or hardware of the computing device, a call from a software application stored by at least one memory device of the computing device. A processing device of the computing device is coupled to the at least one memory device via a bus and is configured to execute the software application. The method further includes selectively redirecting, by the software or hardware of the computing device, the call based on a redirection table stored in the at least one memory device, or in a further memory device. The redirection table indicates, based on either or both of a caller address and a called address of a call to one of the resources, a substitute address to which the call is to be forwarded. In an embodiment, the method further includes comparing, by the software or hardware of the computing device, the caller address of the call with a plurality of reference caller addresses indicated in the redirection table, and in case of a hit, redirecting, by the software or hardware of the computing device, the call to the substitute address associated in the redirection table with the reference caller address of the call. In an embodiment, the method further includes comparing, by the software or hardware of the computing device, the called address of the call with a plurality of reference called addresses indicated in the redirection table, and in case of a hit, redirecting, by the software or hardware of the computing device, the call to the substitute address associated in the redirection table with the reference called address of the call. In an embodiment, the method further includes comparing, by the software or hardware of the computing device, the caller address of the call with a plurality of reference caller addresses indicated in the redirection table and the called address of the call with a plurality of reference called addresses indicated in the redirection table, and in case of a hit for both the caller and called addresses, redirecting, by the software or hardware of the computing device, the call to the substitute address associated in the redirection table with the reference caller and called addresses of the call. In an embodiment, the method further includes updating the redirection table.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 schematically illustrates a computing device according to an example embodiment of the present disclosure;

FIG. 2 schematically illustrates a resource calling system based on direct calls from a software application;

FIG. 3 schematically illustrates a resource calling system based on both direct calls and system calls from software applications;

FIG. 4 schematically illustrates a resource access system comprising a redirection module according to an example embodiment of the present disclosure; and

FIG. 5 schematically illustrates a resource access system comprising a redirection circuit according to an example embodiment of the present disclosure.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

In the present disclosure, the following terms will be considered to have the following definitions:
system call: an electronic signal generated by execution of a software application that causes execution of the software application to stop and for a service to be requested from a resource by a privileged component, such as an operating component, on behalf of the software application;
resource: any hardware or software resource capable of being called by a software application by a direct call or system call to a given address, and to which access can be restricted, examples being a peripheral device, such as a hardware accelerator, cryptographic circuit, memory interface, etc., a volatile or non-volatile memory device, or a region or an address range of a memory device, a software service, a cryptographic service, a specific parameter or confidential data;
call redirection: the translation of a call to a given address into a call to another address without the caller being involved in this process.

Generally, in order to support both trusted and non-trusted applications, it would be possible to develop two versions of the software application, one for use in an environment in which it is trusted, and another for use in an environment in which it is not trusted. However, this leads to a technical problem, as it means that a given application code is not reusable on all systems and contexts, leading to additional complexity and cost.

A further difficulty is that, in certain processing environments, two or more software components may be running in isolation from each other and may need to access one or more restricted resources. This may require the application code to be duplicated in each software component, or for each application code to have a specific code for calling a given service provider, again meaning that the software code cannot be reused on all systems and in all contexts.

The present disclosure describes systems and methods that permit the access by a software application to one or more resources to be selectively restricted based on the privilege level of the software application and using a same reusable code.

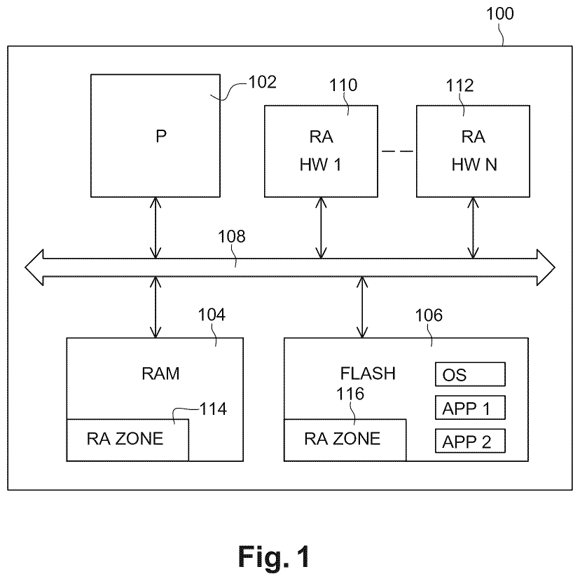

FIG. 1 schematically illustrates a computing device 100 according to an example embodiment of the present disclosure. The computing device 100 is for example implemented by a system-on-chip (SoC). The computing device 100 is for example part of an electronics device such as a IoT (Internet of Things) device, a digital sensor, a digital controller of, for example, an electronic or electro-mechanical system, or the like, or any “smart device” that may benefit from security, such as metering, for example of electricity, water, gas, etc., a body camera, a medical device, such as an insulin pump, heart rate monitor etc., or the like.

The computing device 100 for example comprises a processing device (P) 102 comprising one or more processors, and one or more memory devices, such as volatile memory (RAM) 104 and/or a non-volatile memory (FLASH) 106. In some embodiments, the volatile memory 104 is a random-access memory, and/or the non-volatile memory 106 is a Flash memory, although other types of volatile and non-volatile memories could be present.

The processing device 102 and memories 104, 106 are for example linked by a bus 108, formed for example of an address bus and a data bus (not illustrated individually).

The non-volatile memory 106 for example stores software code, including for example an operating system (OS), which may be a secure operating system and/or a real-time operating system (RTOS), and one or more software applications. Two examples of software applications APP1, APP2 are illustrated in FIG. 1. As known by those skilled in the art, the operating system OS and software applications may be at least partially loaded to the volatile memory 104 and executed by the processing device 102. It would also be possible for the computing device 100 to be a bare metal system without any operating system OS or without a rich operating system, the OS for example being a RTOS.

The computing device 100 further comprises, for example, one or more restricted access hardware devices (RA HW 1, RA HW N) 110, 112 coupled to the bus 108, which are for example peripheral devices, such as communications interfaces, or other types of resources that can only be directly accessed by the OS and/or by one or more of the software applications having the required privileges. Additionally, the volatile memory 104 for example comprises a restricted access zone (RA ZONE) 114, and/or the non-volatile memory 106 for example comprises a restricted access zone (RA ZONE) 116, which are for example hardware resources in the form of memory regions or address ranges that can only be directly accessed by the OS and/or by one or more of the software applications having the required privileges. While not illustrated in FIG. 1, the computing device may additionally implement one or more software resources providing, for example, restricted access services.

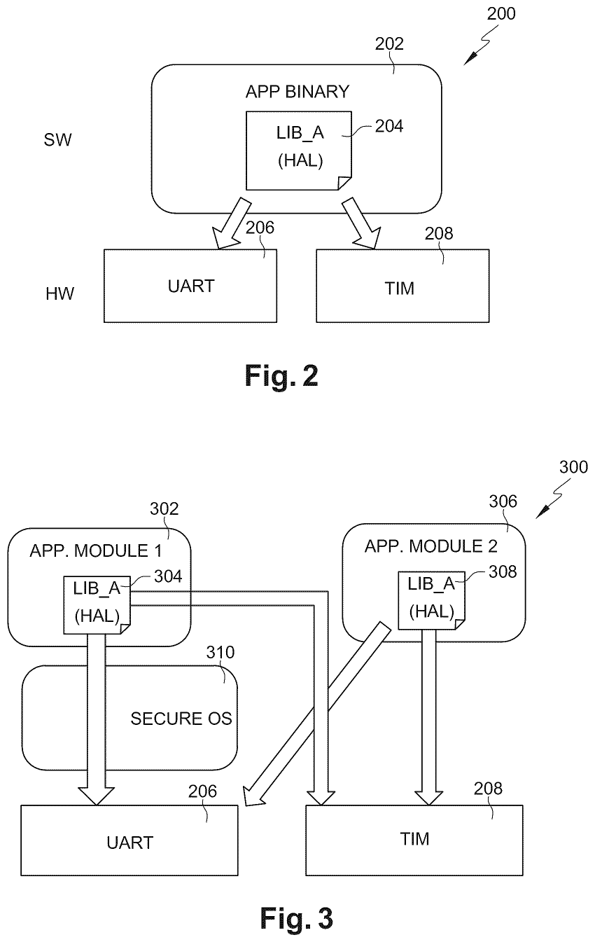

FIG. 2 schematically illustrates a resource calling system 200 based on direct calls from a software application. The system 200 comprises a software application (APP BINARY) 202, corresponding for example to the application APP1 of FIG. 1, and hardware resources (HW) 206, 208. In alterative embodiments, one or more software resources is additionally or alternatively present. The software application 202 for example consists of software code (SW), sometimes referred to as binary code, and includes a library code LIB_A (HAL) 204, which is for example a hardware abstraction layer (HAL) code that permits the software application to make direct calls to the hardware resources 206, 208. Indeed, the system 200 of FIG. 2 is for example a bare metal system in which the software application 202 has all the required privileges to access the hardware or software resources. In the example of FIG. 2, the hardware resource 206 is a UART (Universal Asynchronous Receiver-Transmitter) interface and the hardware resource 208 is a timer unit (TIM).

FIG. 3 schematically illustrates a resource calling system 300 based on both direct calls and system calls from software applications. The system 300 comprises two software applications corresponding for example to the software applications APP1 and APP2 of FIG. 1, a first of the software applications (APP. MODULE 1) 302 comprising a library code LIB_A (HAL) 304, and a second of the software applications (APP. MODULE 2) 306 comprising a library code LIB_A (HAL) 308. The system 300 further comprises an operating system (SECURE OS) 310, which is for example a secure OS. Alternatively, rather than an OS, which has scheduling capabilities, any secure framework acting as a gate keeper (in other words a system not having scheduling capabilities) could be used. The system 300 also for example comprises the hardware resources (HW) 206, 208, which are for example the same as those of FIG. 2. The system 300 could further comprise one or more software resources in addition to or instead of either or both of the hardware resources 206, 208.

The software application 306 for example has similar privileges as the software application 202 of FIG. 2, and can thus call both of the hardware resources 206, 208 directly via the library code 308.

In contrast, the software application 302 for example has a lower level of privileges, and can for example call the hardware resource 208 directly, but must make a system call to the OS 310 in order to access the hardware resource 206.

Thus, while it may be possible to reuse the library code 204 of the software application 202 as the library code 308 of the software application 306, without an addition mechanism for handling the resource calls, the library code 304 of the software application 302 would have to be different from the others in order to handle the two types of calls to the hardware resources 206 and 208.

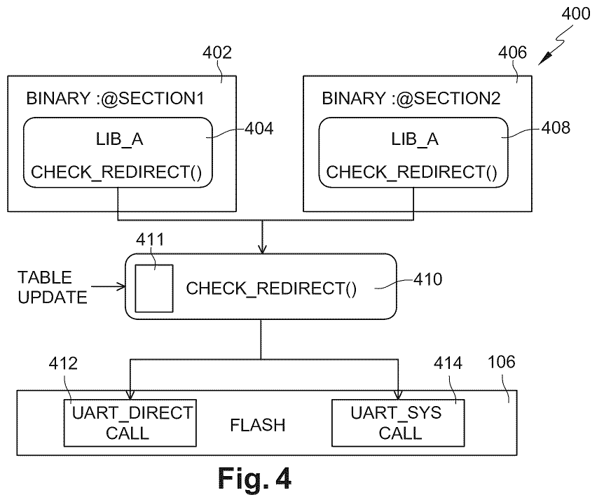

FIG. 4 schematically illustrates a resource access system 400 comprising a redirection module 410 according to an example embodiment of the present disclosure. This system 400 is for example implemented in the computing system 100 of FIG. 1. The system 400 comprises two software applications corresponding for example to the software applications APP1 and APP2 of FIG. 1, a first of the software applications (BINARY: @SECTION1) 402 comprising a library code LIB_A CHECK_REDIRECT( ) 404, and a second of the software applications (BINARY: @SECTION2) 406 comprising a library code LIB_A CHECK_REDIRECT( ) 408, which is for example identical to the library code 404. Thus, the codes 404 and 408 can be reused between the software applications 402, 406, even though these software applications have different privilege levels. This is achieved thanks to a redirection module (CHECK_REDIRECT( ) 410, which is configured to intercept calls from the software applications 402 and 406, and to redirect them based on whether the call is to be made as a direct call or a system call. For this, each of the software applications 402, 406 is for example configured to call a same specific function FuncHR for a given resource HR. In some embodiments, the functions FuncHR are part of software applications 402, 406, such as part of the library codes LIB_A 404, 408 respectively, and have the role of calling the redirection module 410. In particular, the software applications 402, 406 call a service from the library code LIB_A thanks to the function FuncHR, and the function FuncHR invokes the redirection module CHECK_REDIRECT( ) 410. As an example, the function FuncHR=HAL_GPIO_Init. The functions FuncHR for the various resources are all for example stored in the non-volatile memory 106, and each for example contains code that starts by calling the redirection module 410, which for example implements a function CHECK_REDIRECT( ) In this way, the redirection module 410 is able to intercept and process the calls to the functions FuncHR. The redirection module 410 is configured to determine which actual call must be made: a direct call or a system call.

The function CHECK_REDIRECT( ) is for example not platform dependent, and is always the same code. For example, the only parts that may vary from one system to another is the address of this function and the size of the redirection table.

The redirection module 410, and in particular the function CHECK_REDIRECT( ) is for example configured to redirect the call if a redirection is to apply. For example, FIG. 4 illustrates an example in which the resource being called is a UART, and the call is redirected by the redirection module 410 to either: a first memory address 412 corresponding to a UART direct call (UART_DIRECT CALL); or to a second memory address 414 corresponding to a UART system call (UART_SYS CALL). For example, the redirection performed by the redirection module 410 is based on rules stored in a redirection table 411, which is for example part of the redirection module 410. In some embodiments, the redirection table can be updated as represented by an input TABLE UPDATE to the redirection module 410.

When leaving the redirection function CHECK_REDIRECT( ) the stack is for example popped and the link register is for example forced to the redirection address. Furthermore, a branch is for example applied to the redirection address, with the stack from the caller, based on the input parameters and the callee address in the link register. Alternatively, if no redirection is to be applied, then the code flow for example continues with the standard flow.

Tables 1 and 2 below provide examples of the redirection table.

As indicated in Table 1, each of table records #1 to #6 for example defines the rules applying to a call to a given resource at a given called address (Called @) from a given caller address (Caller @) in the software module 402 or 406, that is to say at any address in section 1 (@SECTION1) or any address in section 2 (@SECTION2), or a specific address in one of these sections. In the example of Table 1, there are two resources that can respectively be called by functions FuncA and FuncB respectively. The called addresses of these functions as made by the software applications 402 and 406 are for example addresses with in the redirection module 410, such that the redirection module 410 intercepts and processes these calls. Furthermore, for each table record #1 to #6 there is an indication of the redirection address (Redirected @), in other words the address to which the call should be rerouted by the redirection module 410.

TABLE 1

| Table | | | |
|---|---|---|---|
| record | Caller @ | Called @ | Redirected @ |
| #1 | Exact address of the | &FuncA in | &SyscallFuncA |
| | code I1 doing the | FLASH | |
| | call to FuncA | | |
| #2 | Exact address of the | &FuncB in | &SyscallFuncB |
| | code I2 doing the | FLASH | |
| | call to FuncB | | |
| #3 | Exact address of the | &FuncB in | &SyscallFuncB |
| | code I3 doing the | FLASH | |
| | call to FuncB | | |
| #4 | Caller @ in | Called @ in | called@ + offset |
| | section S1 | range [@1; @2] | |
| #5 | Caller @ in | &FuncA in | &OtherSyscallFuncA |
| | section S2 | FLASH | |
| #6 | Caller @ in RAM | &FuncB in | &DoNothing |
| | | FLASH | |

For example, the record #1 in Table 1 corresponds to a caller address at an exact address of a code I1 that is calling the function FuncA, the record #2 in the table corresponds to a caller address at an exact address of a code I2 that is calling the function FuncB, and the record #3 in the table corresponds to a caller address at an exact address of a code I3 that is calling the function FuncB. The codes I1, I2 and I3 may be in either of the software applications 402 or 406. The functions FuncA and FuncB are for example stored in the non-volatile memory 106, which is for example a FLASH memory. The redirection addresses for records #1, #2 and #3 are for example system calls to the corresponding function, as the codes I1, I2 and I3 do not for example have the require privilege level for directly calling the resources associated with the functions FuncA and FuncB.

For example, the record #4 in Table 1 corresponds to a caller address in the software application 402, in other words within an address range of section S1, the record #5 in the table corresponds to a caller address in the software application 406, in other words within an address range of section S2, and the record #6 in the table corresponds to a caller address with the volatile memory 104, which is for example the RAM. The called address for table record #4 is for example an address range [@1; @2], in other words any address between addresses @1 and @2, and the redirection address is the called address plus an offset. This for example permits a direct call to a resource, but at a modified address. The called address for table record #5 is for example the function FuncA, and the redirection address is a system call to function FuncA, but different to the system call of table record #1, for example because a different device is called in order to access the resource, such as a device that is external to the device 100 of FIG. 1. As one example, the system call is used to access a cryptographic service, such as a decrypt operation involving the use of a confidential key. In a first case, the cryptographic key is for example protected directly in the device 100 itself, and thus a first system call (e.g. the system call of table record #1) is made with all operations carried out within the device 100, which is for example a SoC. In a second case, the cryptographic key may be even more sensitive and an additional access to an external secure component maybe implemented, hence leading to a different system call (e.g. the system call of table record #5). The called address for table record #6 is for example the function FuncB, and this call is for example blocked, and is not redirected, as indicated by the entry “&DoNothing”.

Table 2 indicates in a column “Applicability”, for each table record #1 to #6 of Table 1, further conditions that for example must apply before the redirection is applied. Providing further conditions is optional, and in some cases there may be no further conditions for some or all of the table records, as indicated by the entry “unconditional”. Furthermore, in some cases, a further column “Rejection” indicates, for each table record #1 to #6 of Table 1, what should be done if the condition is not met. If there was no condition, then an entry N.A. (not applicable) is present in this column.

TABLE 2

| Table | | |
|---|---|---|
| record | Applicability | Rejection |
| #1 | Core in unprivileged mode | If applicability checks fail, |
| | Register XX value is YY . . . | trigger a Hard Fault |
| #2 | Unconditional | N.A. |
| #3 | 1. Value at RAM@ XX is YY | Do not perform the redirection, |
| | | call &FuncB |
| #4 | Core in privileged mode | Reset |
| #5 | Secure mode | Exception E1 |
| #6 | Unconditional | N.A. |

Of course, the Tables 1 and 2 above provide just one example of a set of rules for defining call redirections, and many variations are possible, for example depending on the number of resources that can be called, the number of software applications that can issue calls, etc. While examples have been provided in which each table record is defined for a specific caller address and a specific called address, it would also be possible for some or all of the table records to only be defined based on only the caller address or based on only the called address, if for example all calls from a given software code or to a given resource are to be processed in the same way.

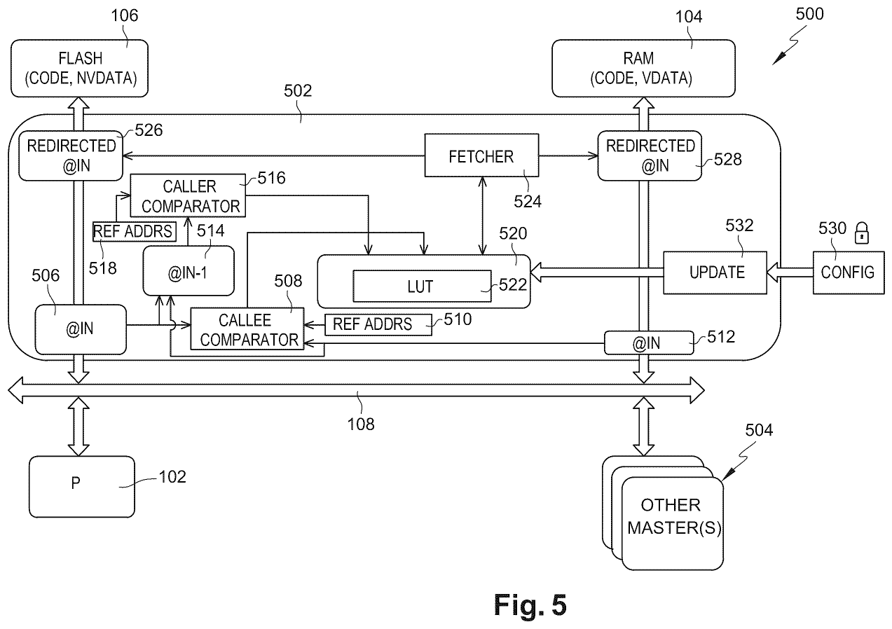

While FIG. 4 illustrates an embodiment in which the call interception and redirection is performed in software by a software module, a hardware implementation is also possible, one example of which will now be described in more detail with reference to FIG. 5.

FIG. 5 schematically illustrates a resource access system 500 comprising a redirection circuit 502 according to an example embodiment of the present disclosure. This system 500 is for example implemented in the computing system 100 of FIG. 1.

For example, the redirection circuit 502 is coupled between the bus 108 and the volatile memory device 104 (RAM (CODE, VDATA)), which stores software code and/or volatile data, and/or between the bus 108 and the non-volatile memory device 106 (FLASH (CODE, NVDATA)), which stores software code and non-volatile data. While FIG. 5 illustrates an example in which a single circuit 502 is coupled between the bus and each of the memory devices 104, 106, in alternative embodiments it would be possible to provide a separate circuit for each memory device 104, 106.

As shown in FIG. 5, the processing device (P) 102 is also coupled to the bus 108, and in some embodiments one or more further master devices (OTHER MASTER(S)) 504 may be coupled to the bus 108 and may be configured to make calls to resources over the bus 108 that may be processed in a similar manner to the calls made by the processing device 102.

The redirection circuit 502 for example comprises a buffer (@IN) 506 coupled to the bus 108 and configured to temporarily store addresses appearing on the address bus of the bus 108 that correspond to addresses within the non-volatile memory 106. The redirection circuit 502 further comprises a comparator (CALLEE COMPARATOR) 508, configured to compare an address in the buffer 506 with one or more reference called addresses, or reference called address ranges, stored for example in a register (REF ADDRS) 510. These reference called addresses, or reference called address ranges, for example correspond to the address or address ranges defined in the “called address” column of the redirection table described above.

Furthermore, the redirection circuit 502 for example comprises a buffer (@IN) 512 coupled to the bus 108 and configured to temporarily store addresses appearing on the address bus of the bus 108 that correspond to addresses within the volatile memory 104. The comparator 508 is for example further configured to compare an address in the buffer 512 with the one or more reference called addresses, or the reference called address ranges, stored in the register 510.

The redirection circuit 502 further comprises, for example, a buffer 514 configured to store a previous address present in the buffer 506 and/or the buffer 512. The redirection circuit 502 further comprises a comparator (CALLER COMPARATOR) 516 configured to compare an address in the buffer 514 with one or more reference caller addresses, or reference caller address ranges, stored for example in a register (REF ADDRS) 518. These reference caller addresses, or reference caller address ranges, for example correspond to the address or address ranges defined in the “caller address” column of the redirection table described above.

The implementation of the circuit 502 of FIG. 5 assumes that, for a given call, the caller address appears on the address bus one clock period before the called address.

Outputs of the comparators 508 and 516 are for example coupled to a memory 520 storing for example a lookup table (LUT) 522 implementing the redirection table described above. In the case that either or both of the comparators 508 and 516 detect a hit, the corresponding caller and/or called address is for example provided as an entry to the lookup table 522, which is configured to determine whether there is a match with one of the records of the redirection table, and if so, to make the redirection address available to an address fetcher (FETCHER) 524. The address fetcher is configured to store the redirection address in either a buffer 526 (REDIRECTED @IN) if the call is to the non-volatile memory 106, or in a buffer 528 (REDIRECTED @IN) if the call is to the volatile memory 104.

An output of the buffer 506 is further coupled to an input of the buffer 526, and an output of the buffer 512 is further coupled to an input of the buffer 528, such that addresses flow through the circuit 502 in a transparent manner if no redirection address is defined. If a redirection address is defined, the fetcher 524 is configured to overwrite, in the buffer 526 or 528, the address transferred from the buffer 506 or 512 by the redirection address.

While not illustrated in FIG. 5, it will be apparent to those skilled in the art that the circuit 502 is a synchronous implementation, each of the components for example being clocked by a common clock signal.

While not illustrated in FIG. 5, the lookup table 522 may take as further inputs additional information in order that the conditions indicated in the “applicability” column of the redirection table described above can be assessed and applied.

Furthermore, in some embodiments, the contents of the lookup table can be updated, as represented by a configuration input (CONFIG) 530 and an update path (UPDATE) 532. In the case the caller or called addresses or address ranges are updated, the new information is for example also stored in the registers 510, 518. In some embodiments, the update mechanism is a secure mechanism that can only be accessed based on an authentication verification using for example one or more cryptographic keys.

Additionally or alternatively, the redirection table of both the hardware implementation (FIG. 5) and of the software implementation (FIG. 4) can for example be stored to a ROM (Read-Only Memory) or as a non-volatile table, for example in Flash memory, which is configured when programming the computing device 100. In some embodiments, the redirection table is write-protected, or updatable under specific conditions, such as readout protection (RDP) regression and/or authentication, by privileged and/or secure software only, based on an option byte, system bit or state pin, etc. As a further variant, the redirection table may be a dynamic RAM table that is configured at each reset or power-down of the computing device 100. The table update may be performed via one or more input pins of the computing device 100, or via a wireless interface such as an OTA (Over The Air) interface.

An advantage of the embodiments described herein is that it is possible to access resources based on a same, reusable code, irrespective of the context in which the software application is used, and in particular irrespective of the privilege level assigned to the software application. Indeed, the restricted access is achieved using the described redirection table, which will either allow the call to proceed as a direct call to the resource, or it will redirect the call as a system call, or it will block the call.

It is an aim of embodiments of the present disclosure to at least partially address one or more needs in the art.

According to one aspect, there is provided a computing device comprising: at least one memory device configured to store a software application; a processing device coupled to the at least one memory device via a bus and configured to execute the software application; and one or more resources capable of being called by the execution of code in the software application, wherein the at least one memory device, or a further memory device of the computing device, is configured to store a redirection table indicating, based on either or both of a caller address and a called address of a call to one of the resources, a substitute address to which the call is to be forwarded, wherein the computing device further comprises software or hardware for intercepting a call from the software application and selectively redirecting the call based on the redirection table.

According to a further aspect, there is provided a method of accessing one or more resources of a computing device, the method comprising: intercepting, by software or hardware of the computing device, a call from a software application stored by at least one memory device of the computing device, wherein a processing device of the computing device is coupled to the at least one memory device via a bus and is configured to execute the software application; and selectively redirecting, by said software or hardware of the computing device, the call based on a redirection table stored in the at least one memory device, or in a further memory device, the redirection table indicating, based on either or both of a caller address and a called address of a call to one of the resources, a substitute address to which the call is to be forwarded.

According to one embodiment, the one or more resources comprise one or more hardware resources such as peripheral devices of the computing device.

According to one embodiment, the one or more resources comprise one or more memory regions of the at least one memory device.

According to one embodiment, the software or hardware for intercepting the call is configured to compare the caller address of the call with a plurality of reference caller addresses indicated in the redirection table, and in case of a hit, to redirect the call to the substitute address associated in the redirection table with the reference caller address of the call.

According to one embodiment, the software or hardware for intercepting the call is configured to compare the called address of the call with a plurality of reference called addresses indicated in the redirection table, and in case of a hit, to redirect the call to the substitute address associated in the redirection table with the reference called address of the call.

According to one embodiment, the software or hardware for intercepting the call is configured to compare the caller address of the call with a plurality of reference caller addresses indicated in the redirection table and to compare the called address of the call with a plurality of reference called addresses indicated in the redirection table, and in case of a hit for both the caller and called addresses, to redirect the call to the substitute address associated in the redirection table with the reference caller and called addresses of the call.

According to one embodiment, the one or more resources capable of being called by the execution of code in the software application comprise: a first resource capable of being called by a call to a first function stored at a first address in the at least one memory device; and a second resource capable of being called by a call to a second function stored at a second address in the at least one memory device.

According to one embodiment, the software or hardware for intercepting the call is a software module stored in the at least one memory device.

According to one embodiment, the software or hardware for intercepting the call is a circuit coupled to the bus and comprising either or both of: a first comparator configured to compare an address on the bus with a reference caller address or reference caller address range; and a second comparator configured to compare an address on the bus with a reference called address or reference called address range.

Various embodiments and variants have been described. Those skilled in the art will understand that certain features of these embodiments can be combined and other variants will readily occur to those skilled in the art. For example, it will be apparent to those skilled in the art that the principles described herein could be applied to any number of resources, which may correspond to peripheral devices or memory regions.

Finally, the practical implementation of the embodiments and variants described herein is within the capabilities of those skilled in the art based on the functional description provided hereinabove.

What is claimed is:

1. A computing device comprising:
at least one memory device configured to store a software application;
a processing device coupled to the at least one memory device via a bus and configured to execute the software application; and
one or more resources capable of being called by the execution of a code in the software application, wherein the at least one memory device, or a further memory device of the computing device, is configured to store a redirection table indicating, based on either or both of a caller address and a called address of a call to one of the resources, a substitute address to which the call is to be forwarded, wherein the computing device further comprises a software for intercepting a call from the software application and selectively redirecting the call based on the redirection table.

2. The computing device of claim 1, wherein the one or more resources comprise one or more hardware resources such as peripheral devices of the computing device.

3. The computing device of claim 1, wherein the one or more resources comprise one or more memory regions of the at least one memory device.

4. The computing device of claim 1, wherein the software for intercepting the call is configured to compare the caller address of the call with a plurality of reference caller addresses indicated in the redirection table, and in case of a hit, to redirect the call to the substitute address associated in the redirection table with the reference caller address of the call.

5. The computing device of claim 1, wherein the software for intercepting the call is configured to compare the called address of the call with a plurality of reference called addresses indicated in the redirection table, and in case of a hit, to redirect the call to the substitute address associated in the redirection table with the reference called address of the call.

6. The computing device of claim 1, wherein the software for intercepting the call is configured to compare the caller address of the call with a plurality of reference caller addresses indicated in the redirection table and to compare the called address of the call with a plurality of reference called addresses indicated in the redirection table, and in case of a hit for both the caller and called addresses, to redirect the call to the substitute address associated in the redirection table with the reference caller and called addresses of the call.

7. The computing device of claim 1, wherein the one or more resources capable of being called by the execution of the code in the software application comprise:
a first resource capable of being called by a call to a first function stored at a first address in the at least one memory device; and
a second resource capable of being called by a call to a second function stored at a second address in the at least one memory device.

8. The computing device of claim 1, wherein the software for intercepting the call is stored in the at least one memory device.

9. A computing device comprising:
one or more resources;
one or more memory devices configured to store:
a software application; and
a redirection table, wherein the redirection table indicates, based on either or both of a caller address and a called address of a call to one of the one or more resources, a substitute address to which the call is to be forwarded;
a processing device coupled to the one or more memory devices and configured to execute the software application, wherein the processing device is configured to generate the call to the one of the one or more resources; and
a circuit for intercepting the call and forwarding the call to the substitute address according to the redirection table.

10. The computing device of claim 9, wherein the circuit comprises:
a first comparator configured to compare the caller address of the call to a reference caller address or reference caller address range; or
a second comparator configured to compare the called address of the call to a reference called address or reference called address range.

11. The computing device of claim 10, wherein the circuit further comprises one of the one or more memory devices configured to store the redirection table.

12. The computing device of claim 9, further comprising a bus configured to couple the processing device, the one or more memory devices, the one or more resources, and the circuit to each other.

13. The computing device of claim 9, wherein the circuit is configured to update the redirection table.

14. The computing device of claim 9, wherein the one or more resources comprise one or more hardware resources such as peripheral devices of the computing device.

15. The computing device of claim 9, wherein the one or more resources comprise one or more memory regions of the one or more memory devices.

16. A method of accessing one or more resources of a computing device, the method comprising:
intercepting, by a software or hardware of the computing device, a call from a software application stored by at least one memory device of the computing device, wherein a processing device of the computing device is coupled to the at least one memory device via a bus and is configured to execute the software application; and
selectively redirecting, by the software or hardware of the computing device, the call based on a redirection table stored in the at least one memory device, or in a further memory device, the redirection table indicating, based on either or both of a caller address and a called address of a call to one of the resources, a substitute address to which the call is to be forwarded.

17. The method of claim 16, further comprising:
comparing, by the software or hardware of the computing device, the caller address of the call with a plurality of reference caller addresses indicated in the redirection table; and
in case of a hit, redirecting, by the software or hardware of the computing device, the call to the substitute address associated in the redirection table with the reference caller address of the call.

18. The method of claim 16, further comprising:
comparing, by the software or hardware of the computing device, the called address of the call with a plurality of reference called addresses indicated in the redirection table; and
in case of a hit, redirecting, by the software or hardware of the computing device, the call to the substitute address associated in the redirection table with the reference called address of the call.

19. The method of claim 16, further comprising:
comparing, by the software or hardware of the computing device, the caller address of the call with a plurality of reference caller addresses indicated in the redirection table and the called address of the call with a plurality of reference called addresses indicated in the redirection table; and
in case of a hit for both the caller and called addresses, redirecting, by the software or hardware of the computing device, the call to the substitute address associated in the redirection table with the reference caller and called addresses of the call.

20. The method of claim 16, further comprising updating the redirection table.
